(19) United States
(12) Patent Application Publication
(10) Pub. No.: US 2025/0029109 A1
(43) Pub. Date: Jan. 23, 2025

(54) WARRANTY-TERMS SETTING SYSTEM AND WARRANTY-TERMS SETTING METHOD

(71) Applicant: HONDA MOTOR CO., LTD., Tokyo (JP)

(72) Inventors: Hodaka Tsuge, Tokyo (JP); Hiroshi Ishikawa, Tokyo (JP); Naotaka Morita, Tokyo (JP)

(21) Appl. No.: 18/754,343

(22) Filed: Jun. 26, 2024

(30) Foreign Application Priority Data
Jul. 21, 2023 (JP) 2023-119138

(51) Int. Cl. G06Q 30/012

(52) U.S. Cl. CPC G06Q 30/012

(57) ABSTRACT

A warranty-terms setting system includes a remaining-lifetime consumption-degree predicting unit that predicts a remaining-lifetime consumption degree based on usage history information on another mobile unit other than a subject mobile unit by a first user, the remaining-lifetime consumption degree being indicative of to what degree the remaining lifetime of the subject mobile unit has been consumed per predetermined period, a predicted remaining-lifetime decreasing period calculating unit that, based on the remaining-lifetime consumption degree, calculates a predicted remaining-lifetime decreasing period indicative of a predicted period in which a remaining lifetime of the subject mobile unit decreases from the determined remaining lifetime to a predetermined criterion value or lower when it is assumed that the first user uses the subject mobile unit after the point of determination, and a warranty-terms setting unit that sets warranty terms for the subject mobile unit based on the predicted remaining-lifetime decreasing period.

### INCORPORATION BY REFERENCE

The present application claims priority under 35 U.S.C. § 119 to Japanese Patent Application No. 2023-119138 filed on Jul. 21, 2023. The content of the application is incorporated herein by reference in its entirety.

### BACKGROUND OF THE INVENTION

### Field of the Invention

The present invention relates to a warranty-terms setting system and a warranty-terms setting method.

### Description of the Related Art

Conventionally, a shovel management system has been proposed that calculates warranty details information associated with the fatigue degree of a shovel to be assessed based on an operating state of the shovel and displays the warranty details information (see Japanese Patent Laid-Open No. 2021-155930, for example). In the management system, if the remaining lifetime of an attachment calculated by a fatigue-degree calculating unit is longer than a reference remaining lifetime, an additional warranty period is set, or if the remaining lifetime is shorter than the reference remaining lifetime, the normal warranty period is just applied.

In the management system described in the Description of the Related Art section, a warranty period is set depending on the remaining lifetime of an attachment based on its fatigue degree. However, the remaining lifetime of a mobile unit such as a vehicle varies depending on usages of the mobile unit by a user of the mobile unit. Therefore, with the management system described in the Description of the Related Art section, proper warranty terms inconveniently cannot be set depending on usages of an individual user.

The present application was made in view of such a background, and it is an object of the present application to provide a warranty-terms setting system and a warranty-terms setting method by which warranty terms for a mobile unit such as a vehicle can be properly set depending on usages of the mobile unit by a user.

### SUMMARY OF THE INVENTION

As a first aspect for achieving the object, there may be provided a warranty-terms setting system including a point-of-determination remaining-lifetime recognizing unit that recognizes a time-point-of-determination remaining-lifetime indicative of a remaining lifetime of a subject mobile unit at a point of determination, a remaining-lifetime consumption-degree predicting unit that predicts a remaining-lifetime consumption degree based on usage history information on another mobile unit different from the subject mobile unit by a first user who starts using the subject mobile unit after the point of determination, the remaining-lifetime consumption degree being indicative of to what degree the remaining lifetime of the subject mobile unit has been consumed per predetermined period in which the first user uses the subject mobile unit, a predicted remaining-lifetime decreasing period calculating unit that, based on the remaining-lifetime consumption degree, calculates a predicted remaining-lifetime decreasing period indicative of a predicted period in which a remaining lifetime of the subject mobile unit decreases from the determined remaining lifetime to a predetermined criterion value or lower when it is assumed that the first user uses the subject mobile unit after the point of determination, and a warranty-terms setting unit that sets warranty terms for the subject mobile unit based on the predicted remaining-lifetime decreasing period.

The warranty-terms setting system may further include a remaining-lifetime consumption-degree correcting unit that corrects the remaining-lifetime consumption degree based on usages of the subject mobile unit by the first user, and it may be configured such that the predicted remaining-lifetime decreasing period calculating unit re-calculates the predicted remaining lifetime decreasing period based on the corrected remaining-lifetime consumption degree, and that the warranty-terms setting unit resets the warranty terms based on the predicted remaining lifetime decreasing period calculated based on the remaining-lifetime consumption degree after correction by the predicted remaining-lifetime decreasing period calculating unit.

In the warranty-terms setting system, it may be configured such that the point-of-determination remaining-lifetime recognizing unit recognizes the determined remaining lifetime based on usage history information on the subject mobile unit by a second user different from the first user if the subject mobile unit is used by the second user before the point of determination.

In the warranty-terms setting system, it may be configured such that the point-of-determination remaining-lifetime recognizing unit recognizes the determined remaining lifetime for each of a plurality of subject components included in the subject mobile unit, the remaining-lifetime consumption-degree predicting unit predicts the remaining-lifetime consumption degree for each of the plurality of subject components, the predicted remaining-lifetime decreasing period calculating unit calculates the predicted remaining lifetime decreasing period for each of the plurality of subject components, and the warranty-terms setting unit sets warranty terms for the subject mobile unit based on the predicted remaining lifetime decreasing periods of the plurality of subject components.

As a second aspect for achieving the object, there may be provided a computer-executable warranty-terms setting method, the method including a point-of-determination remaining-lifetime recognizing step of recognizing a time-point-of-determination remaining-lifetime indicative of a remaining lifetime of a subject mobile unit at a point of determination, a remaining-lifetime consumption-degree predicting step of predicting a remaining-lifetime consumption degree based on usages on another mobile unit different from the subject mobile unit by a first user who starts using the subject mobile unit after the point of determination, the remaining-lifetime consumption degree being indicative of to what degree the remaining lifetime of the subject mobile unit has been consumed per predetermined period in which the first user uses the subject mobile unit, a predicted remaining-lifetime decreasing period calculating step of, based on the remaining-lifetime consumption degree, calculating a predicted remaining-lifetime decreasing period indicative of a predicted period in which a remaining lifetime of the subject mobile unit decreases from the determined remaining lifetime to a predetermined criterion value or lower when it is assumed that the first user uses the subject mobile unit after the point of determination, and a warranty-terms setting step of setting warranty terms for the subject mobile unit based on the predicted remaining-lifetime decreasing period.

According to the warranty-terms setting system described above, warranty terms for a mobile unit such as a vehicle can be set properly in accordance with usages of the mobile unit by a user.

### BRIEF DESCRIPTION OF THE DRAWINGS

FIG. 1 is an explanatory diagram of a configuration of a warranty-terms setting system;

FIG. 2 is an explanatory diagram of a load and a physical property value to be measured for a subject component;

FIG. 3 is an explanatory diagram of information recorded in a vehicle management database;

FIG. 4 is an explanatory diagram of processing of calculating a remaining lifetime of a vehicle;

FIG. 5 is an explanatory diagram of a remaining-lifetime consumption degree of a vehicle;

FIG. 6 is a first flowchart of processing of setting warranty terms for a vehicle;

FIG. 7 is a second flowchart of processing of setting warranty terms for a vehicle;

FIG. 8 is an explanatory diagram of processing of setting warranty terms for a vehicle; and

FIG. 9 is an explanatory diagram of another example of processing of setting warranty terms for a vehicle.

### DETAILED DESCRIPTION OF THE PREFERRED EMBODIMENTS

### 1. Configuration of Warranty-Terms Setting System

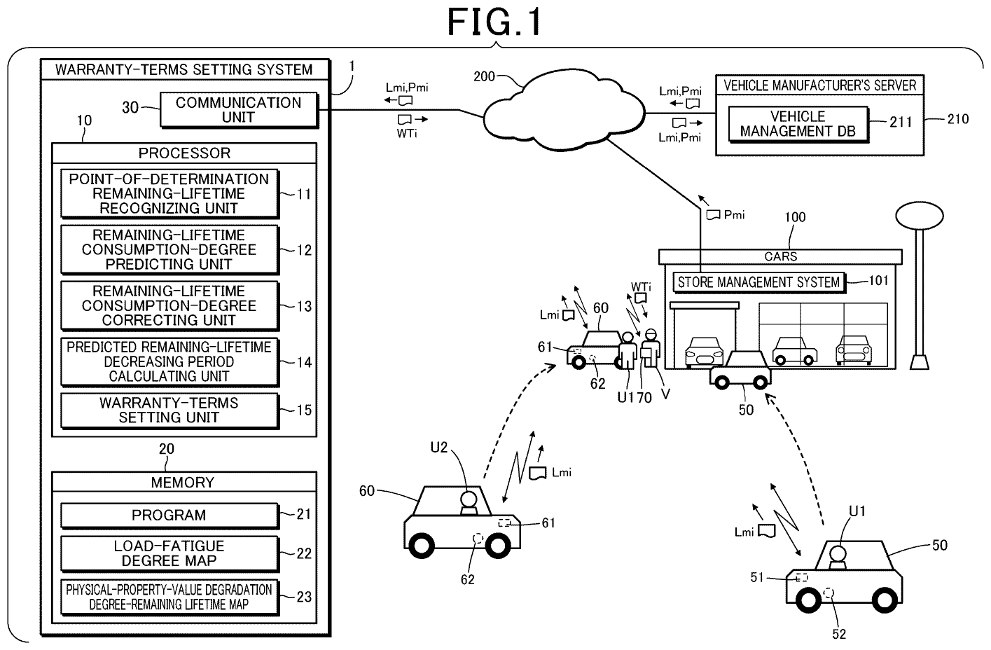

With reference to FIGS. 1 to 5, a configuration of a warranty-terms setting system 1 according to an embodiment is described. The warranty-terms setting system 1 performs processing of setting warranty terms for a vehicle (which corresponds to a mobile unit of the present disclosure) dealt by a car dealer 100. The dealing includes car selling, used-car selling, lease contract, and the like. This embodiment is described where the warranty-terms setting system 1 sets warranty terms for a used subject vehicle 60 (which corresponds to a subject mobile unit of the present disclosure).

FIG. 1 illustrates a case where a first user U1 (new user of the subject vehicle 60) having sold another vehicle 50 used until then by him or her switches to the subject vehicle 60. The other vehicle 50 and the subject vehicle 60 are vehicles from the same manufacturer and are dealt by the car dealer 100, and the usages thereof are managed by a vehicle manufacturer's server 210 that is a management server of a manufacturer which has manufactured those vehicles.

The vehicle manufacturer's server 210 communicates with the other vehicle 50, the subject vehicle 60, and a store management system 101 of the car dealer 100 over a communication network 200. The other vehicle 50 is equipped with sensors 52 that detect a load applied to a subject component of the other vehicle 50, and an electronic control unit (ECU) 51, and the ECU 51 transmits a load measurement information Lmi describing a detection result of a load detected by the sensors 52 to the vehicle manufacturer's server 210 when, for example, the other vehicle 50 is powered on. Similarly, the subject vehicle 60 is equipped with an ECU 61 and sensors 62, and the ECU 61 transmits load measurement information Lmi describing a detection result of a load detected by the sensors 62 to the vehicle manufacturer's server 210 when, for example, the subject vehicle 60 is powered on.

When the other vehicle 50 or the subject vehicle 60 is brought into the car dealer 100 for maintenance such as periodic inspection, a physical property value of a subject component of the other vehicle 50 or the subject vehicle 60 is measured with a measuring instrument by a service staff. Then, the store management system 101 transmits physical-property-value measurement information Pmi describing a measurement result of the physical property value to the vehicle manufacturer's server 210.

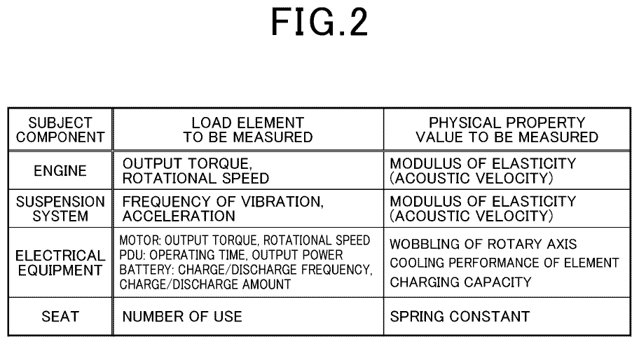

In this embodiment, as shown in FIG. 2, an engine, a suspension system, electrical equipment, and a seat are set as subject components for which load and physical property value are to be measured. For an engine, shaft torque and rotational speed are measured as load elements, and a modulus of elasticity (acoustic velocity) of the component is measured as a physical property value. For a suspension system, a frequency of vibration and an acceleration are measured as load elements, and a modulus of elasticity (acoustic velocity) of the component is measured as a physical property value. For electrical equipment, as load elements, shaft torque and rotational speed of a motor, an operating time and an output power of a power drive unit (PDU), and a charge/discharge frequency and a charge/discharge amount of a battery therefor are measured. Also, as physical property values, wobbling of a rotary axis of the motor, a cooling performance of an element of the PDU, and a charging capacity of the battery are measured. For a seat, the number of uses is measured as a load element, and a spring constant is measured as a physical property value. Load measurement information Lmi and physical-property-value measurement information Pmi for each of subject components of the other vehicle 50 and the subject vehicle 60 are transmitted to the vehicle manufacturer's server 210.

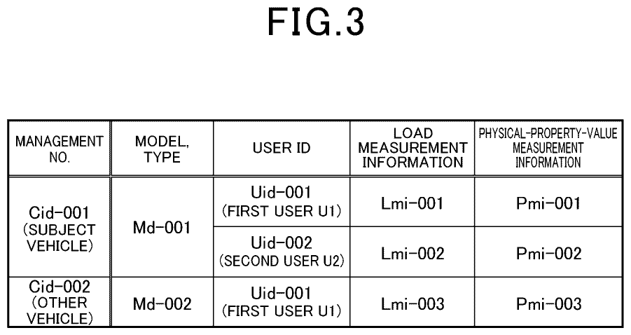

The vehicle manufacturer's server 210 receives the load measurement information Lmi transmitted from the other vehicle 50, the load measurement information Lmi transmitted from the subject vehicle 60, and the physical-property-value measurement information Pmi transmitted from the store management system 101 and records them in the vehicle management database (DB) 211 for each vehicle. FIG. 3 shows record data in the vehicle management DB 211 corresponding to the subject vehicle 60 (Management No.: Cid-001) and the other vehicle 50 (Management No.: Cid-002).

For the subject vehicle 60, a distinction is made between load measurement information (Lmi-001) and physical-property-value measurement information (Pmi-001) for a used period by the first user U1 (user ID: Uid-001) and the load measurement information (Lmi-002) and physical-property-value measurement information (Pmi-002) during a used period by the second user U2. For the other vehicle 50, load measurement information (Lmi-003) and physical-property-value measurement information (Pmi-003) for a used period by the first user U1 is recorded.

The warranty-terms setting system 1 is a computer system including a processor 10, a memory 20, a communication unit 30 and so on. The warranty-terms setting system 1 communicates with the vehicle manufacturer's server 210, a terminal device 70 used by a service staff V of the car dealer 100 and so on over the communication network 200 via the communication unit 30. The terminal device 70 is a tablet terminal, a personal computer, a smartphone or the like.

The memory 20 stores a program 21 for control over the warranty-terms setting system 1, a map (load-fatigue degree map) 22 to be used for converting a load detection value indicated by load measurement information Lmi of a subject component to a weight for the fatigue degree of the subject component, a map (physical-property-value degradation degree-remaining lifetime map) 23 to be used for converting a measured value for the physical property value indicated by physical-property-value measurement information Pmi on a subject component to an estimated remaining lifetime of the subject component.

The processor 10 reads and executes the program 21 so as to function as a point-of-determination remaining-lifetime recognizing unit 11, a remaining-lifetime consumption-degree predicting unit 12, a remaining-lifetime consumption-degree correcting unit 13, a predicted remaining-lifetime decreasing period calculating unit 14, and a warranty-terms setting unit 15. Processing to be executed by the point-of-determination remaining-lifetime recognizing unit 11 corresponds to a point-of-determination remaining-lifetime recognizing step of a warranty-terms setting method of the present disclosure, and processing to be executed by the remaining-lifetime consumption-degree predicting unit 12 corresponds to a remaining-lifetime consumption-degree predicting step of the warranty-terms setting method of the present disclosure. Processing to be executed by the predicted remaining-lifetime decreasing period calculating unit 14 corresponds to a predicted remaining-lifetime decreasing period calculating step of the warranty-terms setting method of the present disclosure, and processing to be executed by the warranty-terms setting unit 15 corresponds to a warranty-terms setting step of the present disclosure.

The point-of-determination remaining-lifetime recognizing unit 11 recognizes a remaining lifetime of a subject component (engine, suspension system, electrical equipment, seat) of the subject vehicle 60 at a time-point of sales when the subject vehicle 60 is sold to the first user U1 (corresponding to point of determination of the present disclosure). The point-of-determination remaining-lifetime recognizing unit 11 recognizes a remaining lifetime of each subject component in accordance with a technique described in, for example, Japanese Patent Application No. 2022-172125 that is a prior patent application by the present applicant, based on load measurement information Lmi and physical-property-value measurement information Pmi on each subject component for a used period by the second user U2 who is the previous user of the subject vehicle 60, which is recorded in the vehicle management DB 211.

The point-of-determination remaining-lifetime recognizing unit 11 acquires a corresponding weight by applying the load recognized from the load measurement information Lmi on the subject component for a used period by the second user U2 to the load-fatigue degree map 22, calculates a cumulative fatigue degree by summing a weighted number of measurements for each load level, and subtracts it from 100% to acquire a first estimated remaining lifetime. The point-of-determination remaining-lifetime recognizing unit 11 further applies a physical-property-value degradation degree recognized from the physical-property-value measurement information Pmi to the physical-property-value degradation degree-remaining lifetime map 23 to recognize a second estimated remaining lifetime of the subject component.

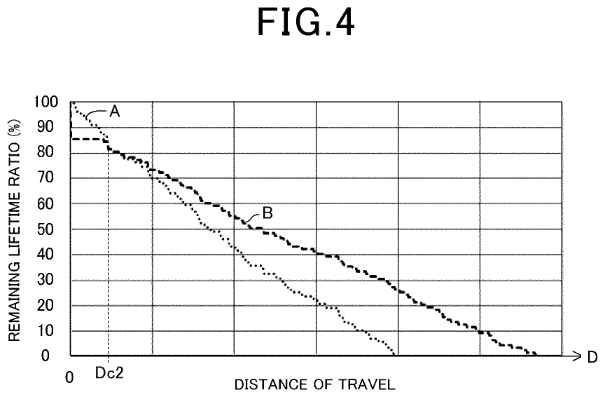

FIG. 4 illustrates, for a subject component of the subject vehicle 60, a first estimated remaining lifetime A based on load measurement information Lmi and a second estimated remaining lifetime B based on physical-property-value measurement information Pmi, with remaining lifetime ratio (a ratio of remaining lifetime where the lifetime is 100%) set on the vertical axis and warranty distance of travel of the subject vehicle 60 corresponding to the remaining lifetime set on the horizontal axis. Referring to FIG. 4, after the traveling distance of the subject vehicle 60 reaches Dc2, the second estimated remaining lifetime B is longer than the first estimated remaining lifetime A.

Therefore, the point-of-determination remaining-lifetime recognizing unit 11 determines the remaining lifetime of the subject component based on the first estimated remaining lifetime A for the period before Dc2 at which the second estimated remaining lifetime B is longer than the first estimated remaining lifetime A. Also, the point-of-determination remaining-lifetime recognizing unit 11 recognizes the remaining lifetime of the subject component based on the second estimated remaining lifetime B for the period after Dc2 where the second estimated remaining lifetime B is longer than the first estimated remaining lifetime A.

The remaining-lifetime consumption-degree predicting unit 12 calculates a remaining-lifetime consumption degree of each subject component (engine, suspension system, electrical equipment, seat) of the subject vehicle 60 after the first user U1 starts use of the subject vehicle 60 based on the load measurement information Lmi-003 and physical-property-value measurement information Pmi-003 for the used period of the other vehicle 50 by the first user U1 shown in FIG. 3. The remaining-lifetime consumption degree indicates a length of the remaining lifetime of a subject component estimated to be consumed (or decrease) when the first user U1 uses the other vehicle 50 for one year. The remaining-lifetime consumption degree of each subject component takes a value acquired by dividing the number of years for a decrease of the remaining lifetime of the subject component in the period in which the first user U1 uses the other vehicle 50 by the number of years that the first user U1 uses the other vehicle 50. The number of years for a decrease of the remaining lifetime of each subject component is calculated by subtracting a remaining lifetime of the subject component at a time-point when the first user U1 switches from the other vehicle 50 to the subject vehicle 60 from the remaining lifetime of the subject component at a time-point when the first user U1 has started the use of the other vehicle 50. The remaining lifetime of each subject component is calculated by the same processing as the above-described processing for recognizing a remaining lifetime by the point-of-determination remaining-lifetime recognizing unit 11.

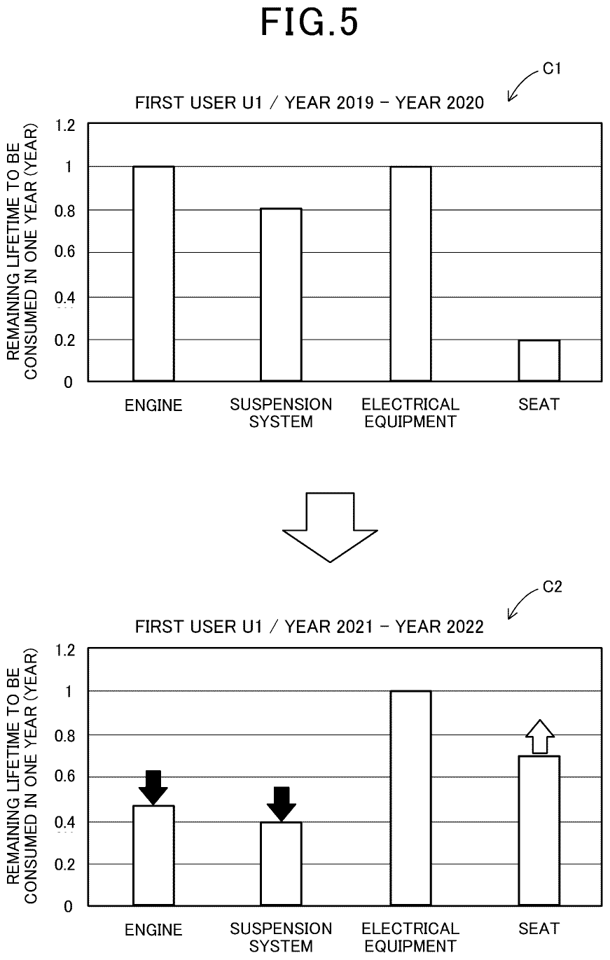

Here, Reference C1 in FIG. 5 denotes an example where the remaining-lifetime consumption degree of each subject component (engine, suspension system, electrical equipment, seat) of the subject vehicle 60 for a predetermined period (year 2019 to year 2020) after the first user U1 has started the use of the subject vehicle 60 is predicted in terms of the remaining lifetime (in years) to be consumed in one year.

The remaining-lifetime consumption-degree correcting unit 13 sets, as a new remaining-lifetime consumption degree, a remaining-lifetime consumption degree of each subject component of the subject vehicle 60 which reflects the actual usages of the subject vehicle 60 by the first user U1 based on the load measurement information Lmi-002 and the physical-property-value measurement information Pmi-002 for the period after the first user U1 has started use of the subject vehicle 60, shown in FIG. 3.

Reference C2 in FIG. 5 illustrates a remaining-lifetime consumption degree of each subject component (engine, suspension system, electrical equipment, seat) of the subject vehicle 60, which is corrected by the remaining-lifetime consumption-degree correcting unit 13. In C2, compared with the remaining-lifetime consumption degree of each subject component in C1 which is predicted when the first user U1 starts use of the subject vehicle 60, the remaining-lifetime consumption degrees of the engine and suspension system decrease while the remaining-lifetime consumption degree of the seat increases. This means that the increased frequency of use of the subject vehicle 60 by the first user U1 with a fellow passenger thereon, for example, results in gentle driving.

For each subject component of the subject vehicle 60, the predicted remaining-lifetime decreasing period calculating unit 14 calculates a predicted remaining lifetime decreasing period that is a predicted period for a decrease of the remaining lifetime of the subject component down to a predetermined criterion value after the first user U1 starts use of the subject vehicle 60. Based on the predicted remaining lifetime decreasing period of each subject component of the subject vehicle 60, which is calculated by the predicted remaining-lifetime decreasing period calculating unit 14, the warranty-terms setting unit 15 sets warranty terms for the subject vehicle 60 for the first user U1.

### 2. Processing of Setting Warranty Terms for Vehicle

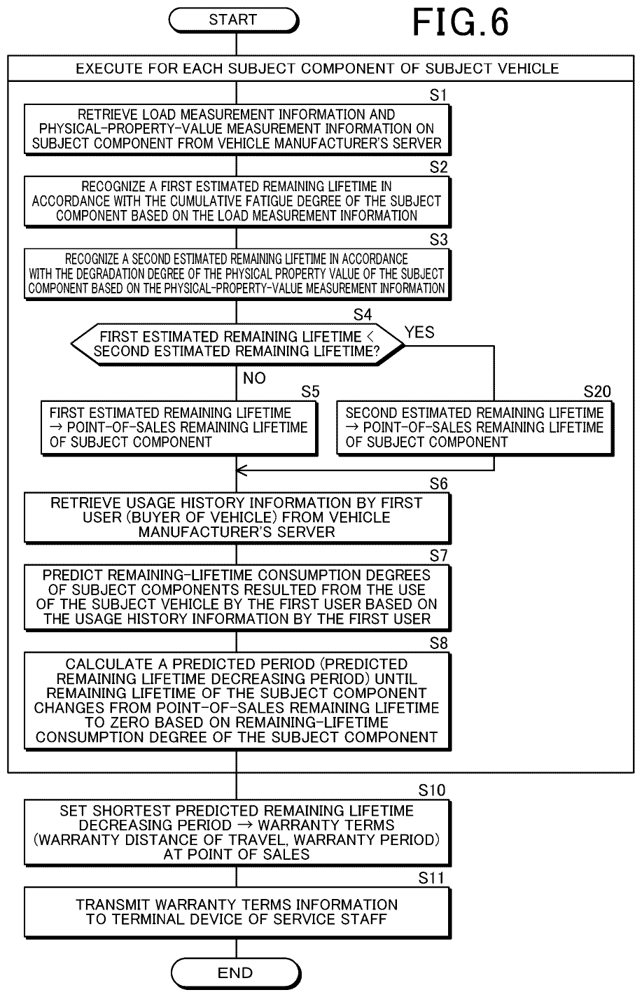

By following the flowchart shown in FIG. 6, steps of processing of setting warranty terms for the subject vehicle 60 with respect to the first user U1, which is executed by the warranty-terms setting system 1, are described. When the subject vehicle 60 is sold to the first user U1, the warranty-terms setting system 1 sets warranty terms for the subject vehicle 60 and changes the warranty terms for the subject vehicle 60 in accordance with the subsequent usages of the subject vehicle 60 by the first user U1.

The warranty-terms setting system 1 performs processing in steps S1 to S8 and S20 in FIG. 6 for each subject component (engine, suspension system, electrical equipment, seat) of the subject vehicle 60. The steps S1 to S5 and S20 are processing by the point-of-determination remaining-lifetime recognizing unit 11. In step S1, the point-of-determination remaining-lifetime recognizing unit 11 accesses the vehicle management DB 211 in the vehicle manufacturer's server 210 and retrieves load measurement information Lmi and physical-property-value measurement information Pmi on the subject component recorded in the vehicle management DB 211 for a period before the point of sales.

In the subsequent step S2, the point-of-determination remaining-lifetime recognizing unit 11 recognizes a first estimated remaining lifetime in accordance with the cumulative fatigue degree of the subject component based on the load measurement information Lmi. In the next step S3, the point-of-determination remaining-lifetime recognizing unit 11 recognizes a second estimated remaining lifetime in accordance with the degradation degree of the physical property value of the subject component based on the physical-property-value measurement information Pmi. Then, in step S4, the point-of-determination remaining-lifetime recognizing unit 11 determines whether the second estimated remaining lifetime is longer than the first estimated remaining lifetime or not, and, if the second estimated remaining lifetime is longer than the first estimated remaining lifetime, the processing moves to step S20, or, if the second estimated remaining lifetime is shorter than or equal to the first estimated remaining lifetime, the processing moves to step S5.

In step S5, the point-of-determination remaining-lifetime recognizing unit 11 sets the first estimated remaining lifetime as a point-of-sales remaining lifetime of the subject component. In step S20, the point-of-determination remaining-lifetime recognizing unit 11 sets the second estimated remaining lifetime as the point-of-sales remaining lifetime of the subject component. The subsequent steps S6 and S7 are processing by the remaining-lifetime consumption-degree predicting unit 12. In step S6, the remaining-lifetime consumption-degree predicting unit 12 accesses the vehicle management DB 211 in the vehicle manufacturer's server 210 and retrieves load measurement information Lmi and physical-property-value measurement information Pmi (Lmi-003, Pmi-003 in FIG. 3) on subject components of the other vehicle 50 which is usage history information on the other vehicle 50 by the first user U1 and is recorded in the period during which the first user U1 uses the other vehicle 50.

In the next step S7, the remaining-lifetime consumption-degree predicting unit 12 predicts remaining-lifetime consumption rates of subject components resulted from the use of the subject vehicle by the first user U1 (see C1 in FIG. 5) based on the usage history information on the other vehicle 50 by the first user U1. The subsequent step S8 is processing by the predicted remaining-lifetime decreasing period calculating unit 14.

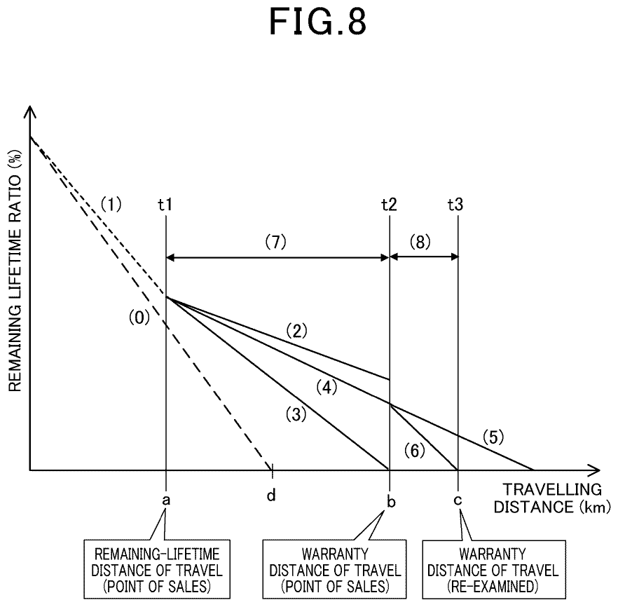

With reference to FIG. 8, processing of calculating a predicted remaining lifetime decreasing period by the predicted remaining-lifetime decreasing period calculating unit 14 is described below. FIG. 8 shows a case where setting and re-examination of warranty terms for one subject component of the subject vehicle 60 is performed. FIG. 8 shows changes in decrease of the remaining lifetime of the subject component in accordance with the traveling distance (cumulative traveling distance) of the subject vehicle 60, with remaining lifetime (remaining lifetime rate) of the subject component set on the vertical axis and traveling distance of the subject vehicle set on the horizontal axis. Reference t1 in FIG. 8 denotes a time point when the subject vehicle 60 is sold to the first user U1.

Reference (0) in FIG. 8 denotes changes in decrease of the remaining lifetime acquired by multiplying a measured value of the remaining lifetime of the subject component acquired from a tolerance test that is carried out in the vehicle manufacturer for the model of the subject vehicle 60 by a weighting coefficient, and Reference (1) denotes changes in decrease of the remaining lifetime to the point-of-sales remaining lifetime, which is recognized by the point-of-determination remaining-lifetime recognizing unit 11.

Reference (2) denotes changes in decrease of the remaining lifetime of the subject component when applying the remaining-lifetime consumption degree of the subject component when the first user U1 uses the subject vehicle 60, which is predicted by the remaining-lifetime consumption-degree predicting unit 12.

Reference (3) denotes changes in decrease of the remaining lifetime of the subject component, which is acquired by multiplying (2) by a weighting coefficient for giving some allowance to the warranty terms, and, at a time point t2 (time point when the traveling distance of the subject vehicle 60 reaches b), the remaining lifetime of the subject component is zero. Accordingly, the predicted remaining-lifetime decreasing period calculating unit 14 calculates the period from t1 to t2 as a predicted remaining lifetime decreasing period.

In the subsequent steps S10 and S11 are processing by the warranty-terms setting unit 15. The warranty-terms setting unit 15 sets, as warranty terms (warranty period, warranty distance of travel) for the subject vehicle 60 at the point of sales, the shortest predicted remaining lifetime decreasing period among the predicted remaining lifetime decreasing periods of each of the subject components (engine, suspension system, electrical equipment, seat) calculated by the processing in steps S1 to S8 and step S20 and a predicted distance corresponding to the shortest predicted period. It should be noted that if the predicted remaining lifetime decreasing period is shorter than the period to d at which the remaining lifetime of the subject component is zero in the changes in decrease (0) of the remaining lifetime resulting from tolerance test shown in FIG. 8, the warranty-terms setting unit 15 sets the period from t1 to d and the distance corresponding to this period as warranty terms (warranty period, warranty distance of travel) for the subject vehicle 60 at the point of sales.

In the next step S11, the warranty-terms setting unit 15 transmits the warranty terms information indicating the warranty terms for the subject vehicle to the terminal device 70 of the service staff V. The service staff V performs explanation of the warranty terms and so on by showing the warranty terms for the subject vehicle 60 displayed on the terminal device 70 to the first user U1.

### 3. Processing of Changing Warranty Terms for Vehicle

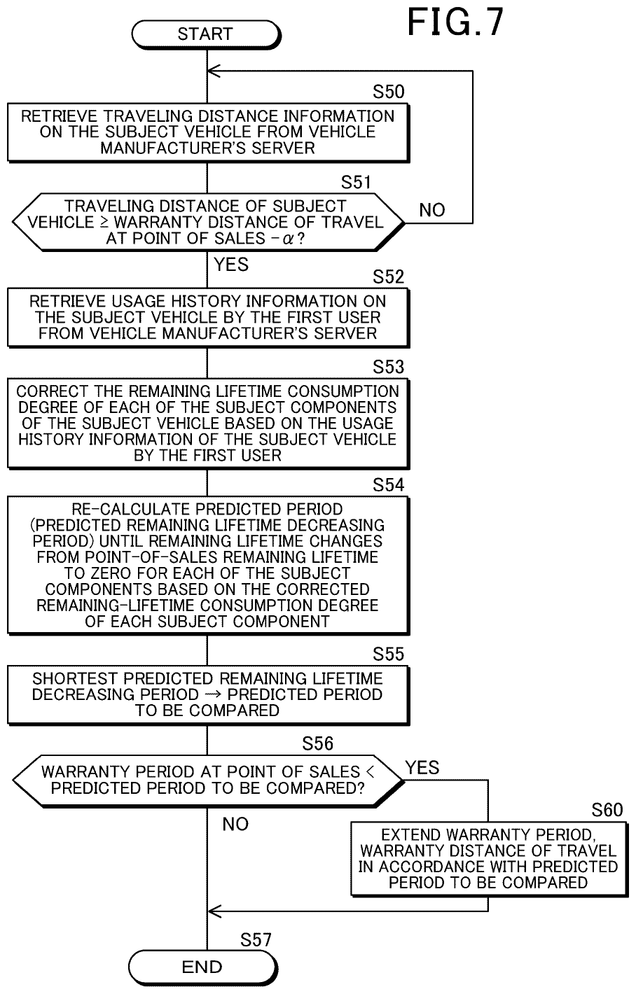

By following the flowchart shown in FIG. 7, steps of processing of resetting warranty terms for the subject vehicle 60 in accordance with the usages of the subject vehicle 60 by the first user U1 after the first user U1 starts use of the subject vehicle 60, which is performed by the warranty-terms setting system 1, are described.

Steps S50 to S53 in FIG. 7 are processing by the remaining-lifetime consumption-degree correcting unit 13. In step S50, the remaining-lifetime consumption-degree correcting unit 13 accesses the vehicle management DB 211 in the vehicle manufacturer's server 210 and retrieves traveling distance information on the subject vehicle 60. In the subsequent step S51, the remaining-lifetime consumption-degree correcting unit 13 determines whether the traveling distance of the subject vehicle 60 is greater than or equal to the warranty distance of travel at point of sales-a (allowance value) or not. Then, the remaining-lifetime consumption-degree correcting unit 13 advances the processing to step S52 if the traveling distance of the subject vehicle 60 is greater than or equal to the warranty distance of travel at point of sales-a or advances the processing to step S50 if the traveling distance of the subject vehicle 60 is less than the warranty distance of travel at the time of sales-a.

In step S52, the remaining-lifetime consumption-degree correcting unit 13 accesses the vehicle management DB 211 in the vehicle manufacturer's server 210 and retrieves load measurement information Lmi and physical-property-value measurement information Pmi (Lmi-001, Pmi-001 in FIG. 3) on each subject component of the subject vehicle 60, which is usage history information on the subject vehicle 60 by the first user U1 and is recorded after the first user U1 starts use of the subject vehicle 60.

In the subsequent step S53, the remaining-lifetime consumption-degree correcting unit 13 corrects the remaining-lifetime consumption-degree of each of the subject components of the subject vehicle 60 (see C2 in FIG. 5) based on the usage history information of the subject vehicle 60 by the first user U1. The next step S54 is processing by the predicted remaining-lifetime decreasing period calculating unit 14. In step S54, the predicted remaining-lifetime decreasing period calculating unit 14 re-calculates a predicted remaining lifetime decreasing period for each of the subject components based on the corrected remaining-lifetime consumption degree.

The subsequent steps S55 to S65 and S60 are processing by the warranty-terms setting unit 15. In step S55, the warranty-terms setting unit 15 handles the shortest predicted remaining lifetime decreasing period among the predicted remaining lifetime decreasing periods of each of the subject components re-calculated in step S54 as a predicted period to be compared. In the next step S56, the warranty-terms setting unit 15 determines whether the predicted period to be compared is longer than the warranty period of the subject vehicle 60 at the point of sales or not.

If the predicted period to be compared is longer than the warranty period of the subject vehicle 60 at the point of sales, the warranty-terms setting unit 15 advances the processing to step S60 where the warranty period of the subject vehicle 60 is extended and advances the processing to step S57. On the other hand, if the predicted period to be compared is less than or equal to the warranty period of the subject vehicle 60 at the point of sales, the warranty-terms setting unit 15 advances the processing to step S57 where, in this case, the warranty period of the subject vehicle 60 is not changed.

Here, Reference (5) in FIG. 8 denotes changes in decrease of the remaining lifetime of the subject component re-calculated by the predicted remaining-lifetime decreasing period calculating unit 14 based on the remaining-lifetime consumption degree of the subject component corrected by the remaining-lifetime consumption-degree correcting unit 13 at or immediately before the time point t2. Also, Reference (6) in FIG. 8 denotes changes in decrease of the remaining lifetime of the subject component, which is acquired by multiplying (5) by a weighting coefficient for giving an allowance to the warranty terms, in which, at a time point t3 (time point when the traveling distance of the subject vehicle 60 reaches c), the remaining lifetime of the subject component is zero. Accordingly, the warranty-terms setting unit 15 extends the warranty distance of travel of the subject component by the period from b-a in (7) at the point of sales to c-b in (8).

### 4. Other Embodiments

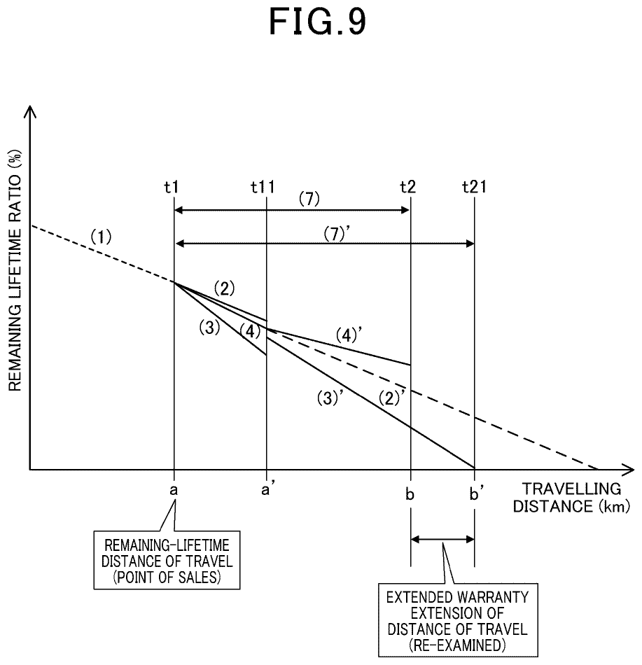

In the embodiment above, by performing the processing by following the flowchart shown in FIG. 7, when the traveling distance of the subject vehicle 60 is close to the warranty distance of travel set at the point of sales, the remaining-lifetime consumption degrees of the subject components are corrected based on the usage history information for the entire used period of the subject vehicle 60 by the first user U1 to change the warranty terms for the subject vehicle 60. According to another embodiment, as shown in FIG. 9, the remaining-lifetime consumption degree may be corrected based on the usage history information for the preceding predetermined period rather than the entire used period of the subject vehicle 60 by the first user U1.

FIG. 9 illustrates changes in decrease of the remaining lifetime of a subject component in accordance with the traveling distance of the subject vehicle 60 with remaining lifetime (remaining lifetime ratio) of the subject component set on the vertical axis and traveling distance of the subject vehicle set on the horizontal axis, similarly to FIG. 8. Like references are given to like elements between FIGS. 8 and 9. Reference t11 in FIG. 9 denotes a time point when the traveling distance of the subject vehicle 60 reaches a′ (a<a′<b).

Reference (4)′ in FIG. 9 denotes an actual result of the remaining-lifetime consumption degree of the subject component from t11 to t2. Based on (4) ‘, the remaining-lifetime consumption-degree correcting unit 13 corrects the remaining-lifetime consumption-degree of the subject component. Reference (2)’ denotes changes in decrease of the remaining lifetime of the subject component, which are calculated with the remaining-lifetime consumption-degree corrected based on (4)′. Reference (3) ‘denotes changes in decrease of the remaining lifetime of the subject component, which are acquired by multiplying the warranty terms by a weighting coefficient for giving an allowance to (2)’ and in which the remaining lifetime of the subject components is zero at a time point t21 (when the traveling distance of the subject vehicle 60 reaches b′).

In this way, by correcting the remaining-lifetime consumption-degree of the subject component based on the actual result of the remaining-lifetime consumption degree in the preceding predetermined period rather than the entire used period of the subject vehicle 60 by the first user U1, the warranty terms for the subject vehicle 60 can be changed so that changes in usages by the first user U1 are better reflected in the middle of the period during which the first user U1 is still using the subject vehicle 60.

While as subject components for which remaining-lifetime consumption degrees are predicted, an engine, a suspension system, electrical equipment, and a seat are illustrated according to the aforementioned embodiment, other components, such as a battery, having a degree of decrease of its remaining lifetime that changes in accordance with the usages of a vehicle may be a subject component.

Having described according to the aforementioned embodiment that the mobile unit of the present disclosure is a vehicle, the mobile unit of the present disclosure may be an aircraft, a ship or the like.

Having described according to the aforementioned embodiment that the remaining-lifetime consumption-degree correcting unit 13 is provided to correct the remaining lifetime consumption degree of each subject component of the subject vehicle 60 based on an actual result of usages of the subject vehicle 60 by the first user U1, a configuration may be adopted in which the remaining-lifetime consumption-degree correcting unit 13 is omitted.

Having described according to the aforementioned embodiment that a predicted remaining lifetime decreasing period is calculated by predicting remaining lifetime consumption degrees for four subject components (engine, suspension system, electrical equipment, seat) of the subject vehicle 60, a predicted remaining lifetime decreasing period may be calculated by predicting remaining lifetime consumption degrees for three or less or five or more subject components.

Having described the subject vehicle 60 that is a used vehicle according to the aforementioned embodiment, the subject vehicle 60 may be a new vehicle. In a case where the subject vehicle 60 is a new vehicle, the point-of-determination remaining-lifetime recognizing unit 11 recognizes a standard remaining lifetime of each subject component in accordance with the model or type of the subject vehicle 60 as a point-of-sales remaining lifetime of the subject component of the subject vehicle 60.

Having described according to the aforementioned embodiment, the warranty-terms setting system 1 that communicates with the vehicle manufacturer's server 210 and the terminal device 70, a part or all of the configuration of the warranty-terms setting system 1 may be constituted of the store management system 101, the vehicle manufacturer's server 210, and the terminal device 70. In a case where the warranty-terms setting system 1 is configured as a part of the functionality of the vehicle manufacturer's server 210, warranty terms information WTi is transmitted from the vehicle manufacturer's server 210 to the terminal device 70. In a case where the warranty-terms setting system 1 is configured as a part of the functionality of the store management system 101, the load measurement information Lmi is transmitted from the vehicle manufacturer's server 210 to the store management system 101, and the warranty terms information WTi is transmitted from the store management system 101 to the terminal device 70.

It should be noted that FIG. 1 is a schematic diagram showing the configuration of the warranty-terms setting system 1 divided into groups of main processing details for easy understanding of the present invention, but the configuration of the warranty-terms setting system 1 may be divided in other manner. Further, processing by each component may be performed by one hardware unit or a plurality of hardware units. Furthermore, processing by each component shown in FIGS. 6 and 7 may be performed by one program or may be performed by a plurality of programs.

### 5. Configurations Supported by Aforementioned Embodiments

The aforementioned embodiments are specific examples of the following configurations.
(Configuration 1) A warranty-terms setting system comprising a point-of-determination remaining-lifetime recognizing unit that recognizes a time-point-of-determination remaining-lifetime indicative of a remaining lifetime of a subject mobile unit at a point of determination, a remaining-lifetime consumption-degree predicting unit that predicts a remaining-lifetime consumption degree based on usage history information on another mobile unit different from the subject mobile unit by a first user who starts using the subject mobile unit after the point of determination, the remaining-lifetime consumption degree being indicative of to what degree the remaining lifetime of the subject mobile unit has been consumed per predetermined period in which the first user uses the subject mobile unit, a predicted remaining-lifetime decreasing period calculating unit that, based on the remaining-lifetime consumption degree, calculates a predicted remaining-lifetime decreasing period indicative of a predicted period in which a remaining lifetime of the subject mobile unit decreases from the time-point-of-determination remaining lifetime to a predetermined criterion value or lower when it is assumed that the first user uses the subject mobile unit after the point of determination; and a warranty-terms setting unit that sets warranty terms for the subject mobile unit based on the predicted remaining-lifetime decreasing period.

According to the warranty-terms setting system of Configuration 1, warranty terms of a mobile unit such as a vehicle can be set properly in accordance with the usages of the mobile unit by a user.
(Configuration 2) The warranty-terms setting system according to Configuration 1, further comprising a remaining-lifetime consumption-degree correcting unit that corrects the remaining-lifetime consumption degree based on usages of the subject mobile unit by the first user, wherein the predicted remaining-lifetime decreasing period calculating unit re-calculates the predicted remaining lifetime decreasing period based on the corrected remaining-lifetime consumption degree, and the warranty-terms setting unit resets the warranty terms based on the predicted remaining lifetime decreasing period calculated based on the corrected remaining-lifetime consumption degree by the predicted remaining-lifetime decreasing period calculating unit.

According to the warranty-terms setting system of Configuration 2, warranty terms of the mobile unit can be set properly by correcting the remaining-lifetime consumption degree in accordance with the usages after the user actually starts use of the mobile unit.
(Configuration 3) The warranty-terms setting system according to Configuration 1 or Configuration 2, wherein the point-of-determination remaining-lifetime recognizing unit recognizes the time-point-of-determination remaining lifetime based on usage history information on the subject mobile unit by a second user different from the first user if the subject mobile unit is used by the second user before the point of determination.

According to the warranty-terms setting system of Configuration 3, the time-point-of-determination remaining lifetime can be properly recognized in accordance with an actual result of use by a past user of the subject mobile unit.
(Configuration 4) The warranty-terms setting system according to Configuration 1 or Configuration 2, wherein the point-of-determination remaining-lifetime recognizing unit recognizes the determined remaining lifetime for each of a plurality of subject components included in the subject mobile unit, the remaining-lifetime consumption-degree predicting unit predicts the remaining-lifetime consumption degree for each of the plurality of subject components, the predicted remaining-lifetime decreasing period calculating unit calculates the predicted remaining lifetime decreasing period for each of the plurality of subject components, and the warranty-terms setting unit sets warranty terms for the subject mobile unit based on the predicted remaining lifetime decreasing periods of the plurality of subject components.

According to the warranty-terms setting system of Configuration 4, since the remaining-lifetime consumption-degree of each subject component varies in accordance with the usages of the subject mobile unit, warranty terms can be set in accordance with the usages of the subject mobile unit by the first user based on the predicted remaining lifetime decreasing periods of a plurality of subject components.
(Configuration 5) A computer-executable warranty-terms setting method, the method comprising a time-point-of-determination remaining-lifetime calculating step of calculating, based on a predetermined remaining lifetime calculation condition, a time-point-of-determination remaining-lifetime indicative of a remaining lifetime of a mobile unit at a point of determination, a remaining-lifetime consumption-degree predicting step of predicting a remaining-lifetime consumption degree of the subject mobile unit per predetermined period in which a user uses the mobile unit based on driving history information of the user who starts use of the mobile unit after the point of determination, a remaining-lifetime changes predicting step of predicting, based on the consumption degree, changes in decrease of the remaining lifetime of the mobile unit by assuming that the user uses the mobile unit after the point of determination, and a warranty-terms setting step of setting a remaining lifetime of the mobile unit predicted by the remaining-lifetime changes predicting step and an estimated traveling distance in a period before a specific time point when a difference from the time-point-of-determination remaining lifetime is less than or equal to a predetermined value or from the point of determination of the mobile unit at the specific time point as warranty terms of the mobile unit at the point of determination.

By implementing the warranty-terms setting method of Configuration 5 by a computer, similar effects to those of the warranty-terms setting system of Configuration 1 can be acquired.

### REFERENCE SIGNS LIST

1: warranty-terms setting system, 10: processor, 11: point-of-determination remaining-lifetime recognizing unit, 12: remaining-lifetime consumption-degree predicting unit, 13: remaining-lifetime consumption-degree correcting unit, 14: predicted remaining-lifetime decreasing period calculating unit, 15: warranty-terms setting unit, 20: memory, 21: program, 22: load-fatigue degree map, 23: physical-property-value degradation degree-remaining lifetime map, 30: communication unit, 50: other vehicle, 51: ECU, 52: sensors, 60: subject vehicle, 61: ECU, 62: sensors, 70: terminal device, 100: car dealer, 101: store management system, 200: communication network, 210: vehicle manufacturer's server, 211: vehicle management DB, U1: first user, U2: second user, V: (car dealer's) service staff

What is claimed is:

1. A warranty-terms setting system comprising:
a point-of-determination remaining-lifetime recognizing unit that recognizes a time-point-of-determination remaining-lifetime indicative of a remaining lifetime of a subject mobile unit at a point of determination;
a remaining-lifetime consumption-degree predicting unit that predicts a remaining-lifetime consumption degree based on usage history information on another mobile unit different from the subject mobile unit by a first user who starts using the subject mobile unit after the point of determination, the remaining-lifetime consumption degree being indicative of to what degree the remaining lifetime of the subject mobile unit has been consumed per predetermined period in which the first user uses the subject mobile unit;
a predicted remaining-lifetime decreasing period calculating unit that, based on the remaining-lifetime consumption degree, calculates a predicted remaining-lifetime decreasing period indicative of a predicted period in which a remaining lifetime of the subject mobile unit decreases from the time-point-of-determination remaining lifetime to a predetermined criterion value or lower when it is assumed that the first user uses the subject mobile unit after the point of determination; and
a warranty-terms setting unit that sets warranty terms for the subject mobile unit based on the predicted remaining-lifetime decreasing period.

2. The warranty-terms setting system according to claim 1, comprising:
a remaining-lifetime consumption-degree correcting unit that corrects the remaining-lifetime consumption degree based on usages of the subject mobile unit by the first user, wherein:
the predicted remaining-lifetime decreasing period calculating unit re-calculates the predicted remaining lifetime decreasing period based on the corrected remaining-lifetime consumption degree, and
the warranty-terms setting unit resets the warranty terms based on the predicted remaining lifetime decreasing period calculated based on the corrected remaining-lifetime consumption degree by the predicted remaining-lifetime decreasing period calculating unit.

3. The warranty-terms setting system according to claim 1, wherein the point-of-determination remaining-lifetime recognizing unit recognizes the time-point-of-determination remaining lifetime based on usage history information on the subject mobile unit by a second user different from the first user if the subject mobile unit is used by the second user before the point of determination.

4. The warranty-terms setting system according to claim 1, wherein:
the point-of-determination remaining-lifetime recognizing unit recognizes the time-point-of-determination remaining lifetime for each of a plurality of subject components included in the subject mobile unit,
the remaining-lifetime consumption-degree predicting unit predicts the remaining-lifetime consumption degree for each of the plurality of subject components,
the predicted remaining-lifetime decreasing period calculating unit calculates the predicted remaining lifetime decreasing period for each of the plurality of subject components, and
the warranty-terms setting unit sets warranty terms for the subject mobile unit based on the predicted remaining lifetime decreasing periods of the plurality of subject components.

5. A computer-executable warranty-terms setting method, the method comprising:
a point-of-determination remaining-lifetime recognizing step of recognizing a time-point-of-determination remaining-lifetime indicative of a remaining lifetime of a subject mobile unit at a point of determination;
a remaining-lifetime consumption-degree predicting step of predicting a remaining-lifetime consumption degree based on usages on another mobile unit different from the subject mobile unit by a first user who starts using the subject mobile unit after the point of determination, the remaining-lifetime consumption degree being indicative of to what degree the remaining lifetime of the subject mobile unit has been consumed per predetermined period in which the first user uses the subject mobile unit;
a predicted remaining-lifetime decreasing period calculating step of, based on the remaining-lifetime consumption degree, calculating a predicted remaining-lifetime decreasing period indicative of a predicted period in which a remaining lifetime of the subject mobile unit decreases from the time-point-of-determination remaining lifetime to a predetermined criterion value or lower when it is assumed that the first user uses the subject mobile unit after the point of determination; and
a warranty-terms setting step of setting warranty terms for the subject mobile unit based on the predicted remaining-lifetime decreasing period.
